(19) United States
(12) Patent Application Publication
(10) Pub. No.: US 2020/0345170 A1
(43) Pub. Date: Nov. 5, 2020

(54) FOOD OR BEVERAGE DISPENSING DEVICE AND METHOD FOR PREPARING A FOOD OR A BEVERAGE FROM ONE OR A PLURALITY OF CONTAINERS

(71) Applicant: SOCiETE DES PRODUiTS NESTLE S.A., Vevey (CH)

(72) Inventors: Christian Jarisch, Lutry (CH); Camille Mairot, Valdahon (FR); Philippe Baenninger, Epalinges (CH)

(21) Appl. No.: 16/762,798

(22) PCT Filed: Oct. 23, 2018
(86) PCT No.: PCT/EP2018/079041

§ 371 Date: May 8, 2020

(30) Foreign Application Priority Data
Nov. 10, 2017 (EP) 17200966.4

(51) Int. Cl. A47J 31/40; B65D 85/804

(52) U.S. Cl. CPC A47J 31/407; A47J 31/4492; B65D 85/8043

(57) ABSTRACT

The invention relates to a food or beverage dispensing device (10) comprising holding means (30) accepting at least two containers (20, 20′) of similar configuration; the holding means (30) being configured to cooperate with receiving means (60) in the device (10) to insert and position the at least two containers (20, 20) in the device (10) for preparing a food or beverage, each container comprising at least an ingredient for the preparation of a food or beverage; the holding means (30) comprising positioning means (31) to position in a certain manner the containers in the holding means (30) and also comprising an interface area (32) for each of the containers placed, such that free access is left to operate the containers injecting a fluid for the preparation of the food or beverage and to open and/or close the dispensing outlet of the food or beverage prepared. The at least two containers (20, 20′) are configured as flexible pouches or sachets. The invention further relates to a food or beverage dispensing system (100) comprising a food or beverage dispensing device (10) as described and at least two containers (20, 20′) provided on holding means (30). The invention also relates to a method for preparing a food or beverage using a food or beverage dispensing system (100).

### FIELD OF THE INVENTION

The present invention relates to a dispensing device preparing a food or a beverage from one or a plurality of containers, each comprising one or multiple ingredients. The invention further relates to a method for preparing such a food or a beverage from the one or more containers.

### BACKGROUND OF THE INVENTION

Beverage preparation systems comprising a machine where one or more containers comprising different ingredients are inserted, are known in the state of the art. The machine is typically configured for being able to pass a fluid, typically hot water, through an ingredient contained in the container, so as to produce a beverage by dissolution (from e.g. milk or chocolate soluble powders), low-pressure infusion (from e.g. leaf tea, loose coffee powder), or high-pressure extraction (from e.g. roast and ground coffee in loose or compacted form). The machine comprises one fluid system with fluid-conducting pipes, a fluid-conducting pump, a fluid source (e.g. a water tank, or a direct plumbing connection valve), and a so-called brewing chamber which is adapted to accommodate said ingredient container and prepare a beverage by mixing said ingredient and said fluid according to the methods described above.

In order to produce more varieties of beverages with one single device, certain different systems have been proposed. For example, it is known in the state of the art WO 16162204 A1 disclosing a brewing device with two separate brewing chambers and two capsule receptacles. The beverage is produced sequentially and can be dispensed stratified. The problem of this system is that it does not allow a wide variety of beverages to be prepared as it only accepts a certain type of capsules and also the machine with the two separate brewing chambers is bulky, complex and expensive, and further requires frequent maintenance and cleaning operations.

Document US 2005076786 A describes a device comprising a pod carrier configured for admitting more than one pod, as an arrangement unit where more than one pod can be stocked. This device is not however configured for preparing versatile beverages with multiple ingredients coming from the content of more than one pod.

It is known in the state of the art a method for preparing a beverage from at least two ingredients dissolved and/or extracted by water being supplied to the ingredients, as per US 2009022864 A. The document discloses two pads arranged one of top of the other, one pad comprising coffee and the other pad comprising milk powder, typically. Water flows first through the coffee pad, overflows and then flows into the milk pad, so the final beverage can be obtained. However, the device disclosed in this document does not allow obtaining more complex beverages from the operation of different containers and does not allow any sequential extraction of the ingredients, for example.

Document WO 16041810 A1 discloses a brewing unit receiving two capsules in a holder and able to operate them sequentially. For this, each capsule needs to be well oriented with respect to the water flow from the brewing unit at the moment when it is processed. Therefore, the holder needs to be re-oriented by displacement or rotation, either done by the machine or by the consumer, taking out the holder and reorienting it appropriately. Therefore, the machine described is either complex or requires manual operations for the consumer which are burdensome and not user friendly.

For example, US 2008121111 A describes a holder accepting two coffee pods, which is entirely moveable thanks to cams and a motor. No recipe or sequential beverage is described in this document though, and the system of extracting the holder requires a complex and bulky automation in the machine. Other devices use for example holders admitting a plurality of capsules or containers, such as described in WO 13110650 A1 for example.

Known in the art is for example a device as the one described in US 2015257580 A, comprising first and second chambers admitting first and second cartridges having different configurations. In order to process one cartridge or a different one, the chambers rotate so they can be accessed on one or another side. However, for allowing such a rotation, the device must be configured in a complex and bulky way and is further expensive. Also, it is not configured to allow the preparation of recipes from the two cartridges, neither would this be practical as it would require several turnings of the chambers for example.

In US 2015257586 A it is described a device having two chambers, each receiving a cartridge of a beverage type. The device comprises a code reader to retrieve the information on the type of beverage in each of the cartridges: once the first beverage type has been determined, for example, the device presents the first cartridge-receiving chamber corresponding to the first beverage type. Further, when the information on the second beverage type is determined, the device presents the second cartridge-receiving chamber corresponding to the second beverage type. However, this simple does not allow preparing recipes from the cartridges for example and the two cartridges cannot be operated simultaneously. Moreover, the device is complex, costly and bulky and does not allow a versatile operation of the cartridges.

Therefore, there exists the need to provide a beverage dispensing device able to admit one or a plurality of containers, with multiple ingredients, that can be operated in a simultaneous or sequential way as desired for the production of various beverages and/or beverage recipes, the device being simple, having the lowest possible amount of mechanical components, being not expensive, automated and user friendly.

The present invention comes to provide a solution to the above-described needs, as it will be further explained. The invention also aims at other objects and particularly at the solution of other problems as will appear in the rest of the present description.

### SUMMARY OF THE INVENTION

According to a first aspect, the invention relates to a food or beverage dispensing device comprising holding means accepting at least two containers of similar configuration; the holding means are configured to cooperate with receiving means in the device to insert and position the at least two containers in the device for preparing a food or beverage, each container comprising at least an ingredient for the preparation of a food or beverage. The holding means comprise positioning means to position in a certain manner the containers in the holding means and also comprise an interface area for each of the containers placed, such that free access is left to operate the containers injecting a fluid for the preparation of the food or beverage and to open and/or close the dispensing outlet of the food or beverage prepared.

Preferably, the at least two containers are configured as flexible pouches or sachets. Typically, the containers are configured with at least a flexible sheet configuring an inner volume where at least a food or beverage ingredient is arranged, the containers being also provided with an insert used as interface with the device.

The at least one flexible sheet is preferably arranged overwrapping the insert in its entirety, except for the part of it communicating with the inner volume of the container.

In one embodiment of the invention, the at least two containers differ in height and/or internal volume.

According to the invention, the food or beverage dispensing device typically comprises a unique fluidic system configured for the delivery of fluid to the at least two containers.

Preferably, the holding means are configured to be completely and/or partially removable from the device. The containers typically present a plane shape oriented along a plane substantially vertically oriented during food or beverage preparation.

In a preferred embodiment of the invention, the food or beverage dispensing device comprises interface means engaging with each one of the containers in the holding means, once introduced in the device. The interface means are preferably arranged opposed to engage with opposed containers in the holding means.

Typically, the at least two containers comprise identification means to engage with a reader in the device and provide information on the processing and dispensing parameters of the food or beverage product. The identification means are preferably configured as mechanical codes, optical codes, RFID tags, bar codes, magnetic codes or the like.

In a preferred embodiment of the food or beverage dispensing device of the invention, it further comprises a user interface to retrieve information from a user with respect to the processing parameters of the containers in the holding means.

Typically, one of the containers comprises a base product for the food or beverage to prepare, and a second container comprises a complementary ingredient for the food or beverage.

According to a second aspect, the invention relates to a food or beverage dispensing system comprising a food or beverage dispensing device as previously described and at least two containers provided on holding means.

Yet according to a third aspect, the invention relates to a method for preparing a food or beverage using a food or beverage dispensing system as described and comprising:
providing at least two containers in holding means and positioning them inside the device;
engaging each of the containers with interface means of the device, injecting a fluid inside the containers to prepare a food or beverage, the interface means also operating the opening and/or closing of the dispensing of the food or beverage product prepared.

Preferably, in the method of the invention, the preparation and/or the dispensing of the food or beverage is done simultaneously or sequentially.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIG. 1 shows a representative view of a food or beverage dispensing device according to an embodiment of the present invention, the device comprising a holder where two containers can be placed and operated in the device.

FIG. 2 shows a representative view of a food or beverage dispensing device as represented in FIG. 1, showing the holder in a closed position in the device.

FIGS. 3a-c show schematic views of a method for preparing a food or beverage from one or a plurality of containers, using a food or beverage dispensing device, according to the invention.

FIG. 4 shows schematically the preparation of a food or beverage from two containers comprising different ingredients, using a food or beverage dispensing device according to the present invention.

FIG. 5 shows the configuration of a typical container to be operated in a food or beverage dispensing device according to the invention, the container comprising an inner volume with at least a food or beverage ingredient and a fitment.

FIGS. 6a-b show a possible embodiment of a fitment in a container to be operated in a food or beverage dispensing device according to the invention.

FIGS. 7a-b show another possible embodiment of a fitment in a container to be operated in a food or beverage dispensing device according to the invention, showing a closed and an open position of the fitment, respectively.

### DETAILED DESCRIPTION OF EXEMPLARY EMBODIMENTS

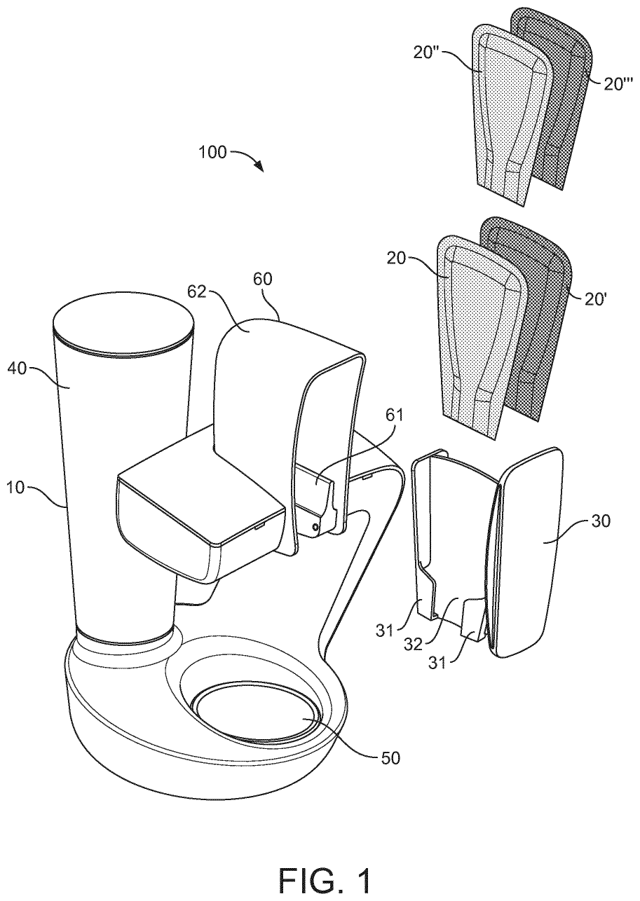

According to a first aspect, the invention relates to a food or beverage dispensing device 10 as schematically represented in FIG. 1. The device comprises a fluid tank 40 where a fluid, typically water, is stored, and receiving means 60 and holding means 30 collaborating in order to hold and introduce one or more containers 20, 20′ in the device 10 for being processed. The device 10 further comprises a receptacle surface 50 where a receptacle 70 will be placed for receiving the food or beverage prepared by the device 10.

Typically, the holding means 30 will be configured for receiving at least two containers, 20 and 20′. The size of the containers may vary typically as to their height, and the same holding means 30 will be able to receive both sizes of containers, 20 and 20′ or 20″ and 20′″. The holding means 30 as represented in FIG. 1 are configured to be completely removable from the device 10. However, other configurations of the holding means 30 are possible, for example those where the holding means are not fully removed from the device but are only partially removed, still allowing placing and removing the containers, for example by tilting the holding means 30 with respect to a rotatable part fixed in the device. As shown in FIG. 1, the holding means 30 are introduced into or removed from the device by guiding means 61: in the Figure represented, the guiding means 61 allow introducing or removing the holding means 30 by sliding them with respect to the guiding means 61. The device 10 is further provided with a housing or cover 62 creating a closed chamber in the device 10 where the container or containers in the holding means 30 will be operated.

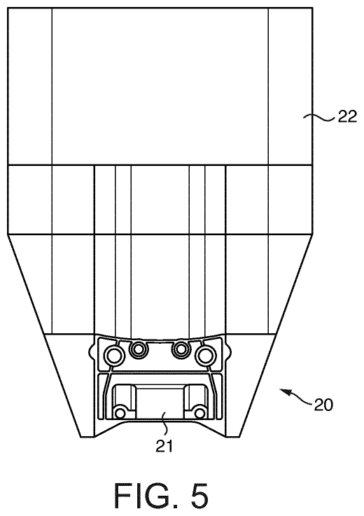

Preferably, the type of containers 20 to be processed in the device 10 will be of the type of pouch or sachet, typically comprising an inner volume 22 and a fitment assembly or insert 21. A preferred example is represented in FIG. 5. The container 20 is typically made by flexible sheets (or by one flexible sheet folded) configuring an inner volume 22. Preferably, the flexible sheets also overwrap and cover the insert 21, which is hygienically desired. The inner volume 22 comprises inside at least an ingredient for the preparation of a food or beverage product, typically in powder form. The interface with the device 10 is the fitment or insert 21, through where a fluid from the fluid tank 40 is introduced into the inner volume 21 to dissolve the powder ingredient inside. When the beverage is prepared, it is dispensed through the insert 21, typically into a receptacle 70.

The container 20 typically presents a plane shape oriented along a plane essentially vertically oriented during beverage production and the fluid injected through the insert is then oriented in a direction comprised in said plane. The fluid jet introduced from the bottom, through the insert 21, into the container, is developing into circular and spiral movements creating turbulences, frictions and high contact surfaces between the fluid molecules (typically, water molecules) and the ingredient particles. In average the fluid molecules have several turns within the container until they leave it together with the beverage or food product once mixed.

According to the invention, the container is arranged essentially vertically during the production and dispensing of the product or beverage, and the insert 21 is arranged in such a way that the fluid is supplied into the container 20 in an upward direction.

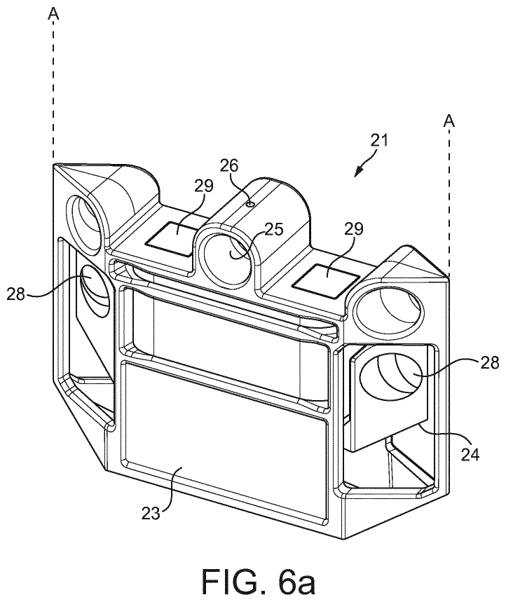

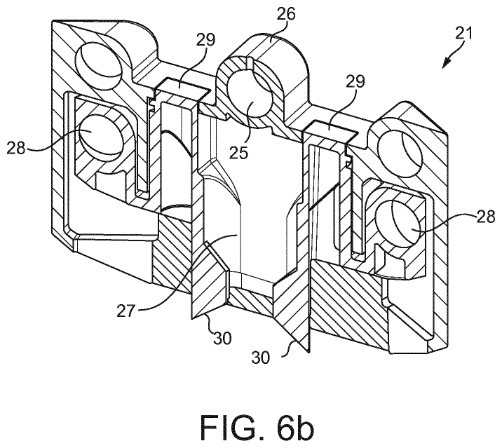

The holding means 30 are configured for receiving at least two containers of the pouch or sachet type and to correctly position them in the device 10. The containers are placed in the holding means 30 and are positioned thanks to the positioning means 31 configured to match with the corresponding part of the container, leaving free an interface area 32 where the insert or spout 2 will be placed and accessed by corresponding piercing and injecting means from the device (not shown). Therefore, the holding means 30 will accept at least two containers, for example 20 and 20′ that will be positioned by resting on the positioning means 31, allowing access to the insert 21 by corresponding piercing and injecting means from the device 10 as the interface area 32 is left free and accessible. Typically, when for example two containers 20 and 20′ are placed in the holding means 30, on each of the sides of it, each spout of each container remains accessible on each of the sides of the holding means 30, through the interface area 32 giving access to each one of the spouts. The device 10 is configured having a unique fluid delivery interface feeding at least two piercing and injecting means, each means collaborating or operating with a corresponding container, more specifically with a corresponding spout of a container. The fluidic system is therefore simple, and so are the piercing and injecting means, which are the same for each of the containers to operate. In fact, the interface of the containers, independently on their size, remains the same, as the spout or fitment assembly is the same, even when the size of the container differs. Further details of the operation of the sachets with respect to their spouts will follow, particularly referring to FIGS. 5, 6a-b and 7a-b. Therefore, the fluidic system conveying the fluid to the containers is unique and is then bifurcated to feed the at least two containers. Then, piercing and injecting means will be provided on each of the sides, for each of the containers, to inject the fluid into the container and operate the opening, dispensing and later closing of the insert or spout of each of the containers.

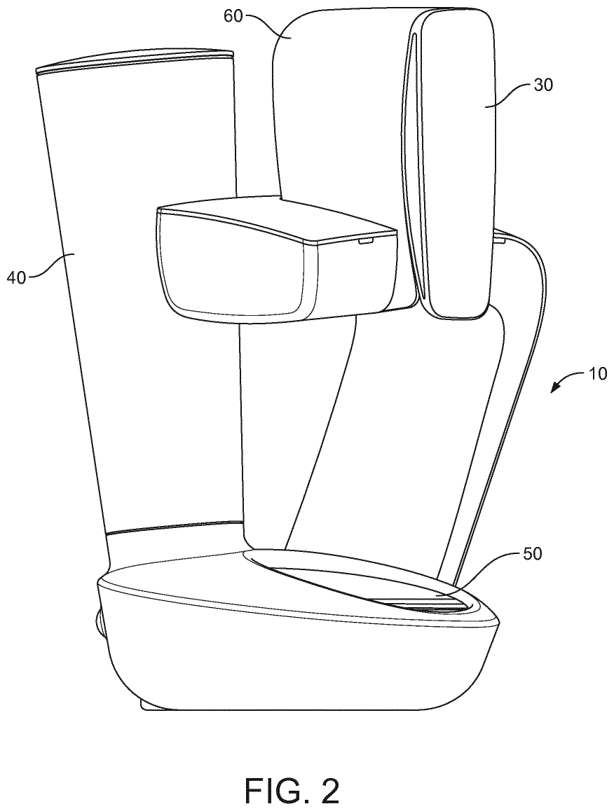

The invention further relates to a food or beverage dispensing system 100, this system comprising a food or beverage dispensing device 10 and one or a plurality of containers 20, these containers being preferably provided with the shape of a flexible pouch or sachet. FIG. 1 shows the system 100 of the invention with the holding means 30 removed from the device 10, and also represents the two types or pouches or sachets, having different sizes, 20 and 20′, and 20″ and 20′″. FIG. 2 shows the system 100 where the holding means 30 (typically ready for preparing a food or beverage and therefore comprising inside the containers) are introduced in the device 10. Looking at FIG. 1, when two containers are placed in the holding means 30, corresponding and opposing piercing and injecting means will come on each of the opposed sides therefore operating the inserts arranged opposed of the corresponding containers, operating as it will be further described in more detail.

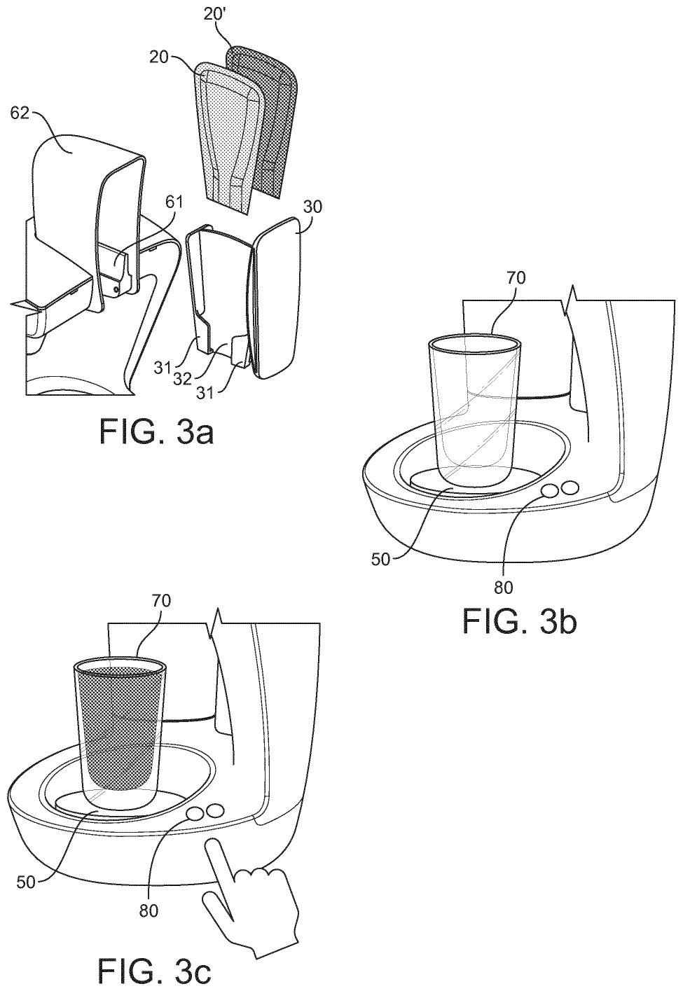

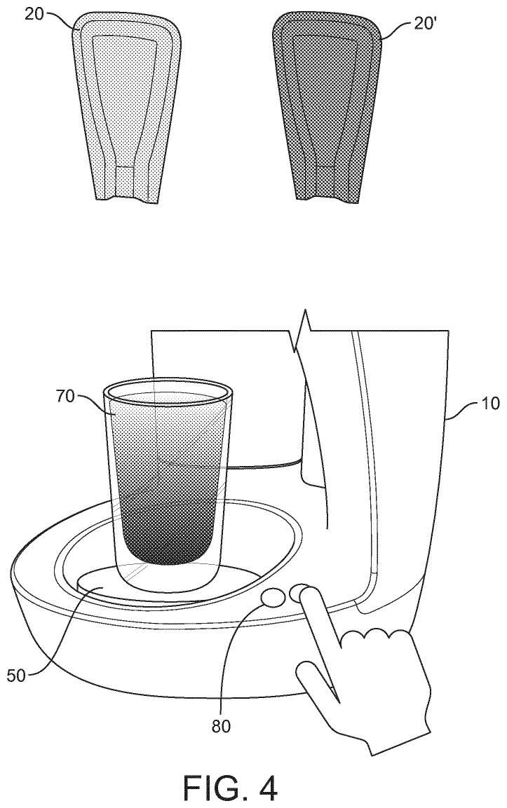

Further, FIG. 3a shows the way typically two containers 20 and 20′ are arranged in the holding means 30, correctly positioned in the positioning means 31 and leaving the inserts operable through the interface areas 32. Once the containers 20 and 20′ are placed in the holding means 30, they are introduced in the device 10 by sliding over the guiding means 61. The guiding means 61 will typically comprise stopping means to stop the sliding of the holding means 30 so as to correctly place the containers (specifically their spouts) facing corresponding piercing and injecting means to operate each container. FIG. 3b shows a receptacle 70, typically shaped as a glass, arranged onto a receptacle surface 50 and ready to receive the food or beverage prepared by the device 10. The device 10 further comprises a user interface 80 by means of which the user can instruct the device 10 on desired aspects or characteristics of the food or beverage to be dispensed. FIG. 3c shows the step when the receptacle 70 is full with the food or beverage prepared inside and ready for consumption.

FIG. 4 exemplifies a device 10 operating two containers 20 and 20′ to prepare a beverage or food product and dispense it in a receptacle 70. Typically, the first container 20 will comprise a base product, such as milk, soya, etc. (powder that will be reconstituted by the addition of water) and the second container 20′ will comprise a complementary product, preferably intended to personalize the beverage, such as fruits, aromas, vitamins, etc. (also typically in powder to be reconstituted by the addition of water). The user can influence the operation of the containers by acting on the user's interface 80.

The food or beverage ingredient of the containers can be comprised within the list of: soups, fruit juices, vegetable juices, bouillons, coffee, chocolate, tea, milk or creamer, smoothies, purees, coulis, creams or a combination thereof. The food or beverage ingredient can be a soluble food or beverage ingredient. Preferably the food or beverage ingredient is a soluble food or beverage ingredient selected in the list of:
instant coffee powder, milk powder, cream powder, instant tea powder, cocoa powder, soup powder, fruit powder or mixture of said powders,
a coffee concentrate, a milk concentrate, a syrup, a fruit or vegetable concentrate, a tea concentrate, a fruit or vegetable puree.

The powders can be agglomerated or sintered. The powders or liquid concentrates can be mixed with solid pieces for example for preparing soups with solid pieces. The food or beverage ingredient can also be an infusable food or beverage ingredient like a roast and ground coffee or tea leaves. In that embodiment water extracts the infusable ingredient.

In the present invention the fluid injected in the containers covers any aqueous diluent that can be mixed with a soluble beverage ingredient to prepare a beverage, like water, carbonated water, milk, etc. However, according to the invention, water is the preferred fluid that will be used.

An example of a container 20 as a pouch or sachet used in the device 10 of the invention is shown in FIG. 5. The container 20 comprises an inner volume 22 where the ingredient is stored (typically a powder) and a fitment assembly or insert 21 through where the fluid is injected. Preferably, the lower shape of the container 20 is configured to cooperate and correctly position the container in the positioning means 31 in the holding means 30. The inner volume 22 is typically made by folding a flexible sheet over the insert 21 overwrapping it except for the inner part of the insert 21 communicating with the inner volume 22.

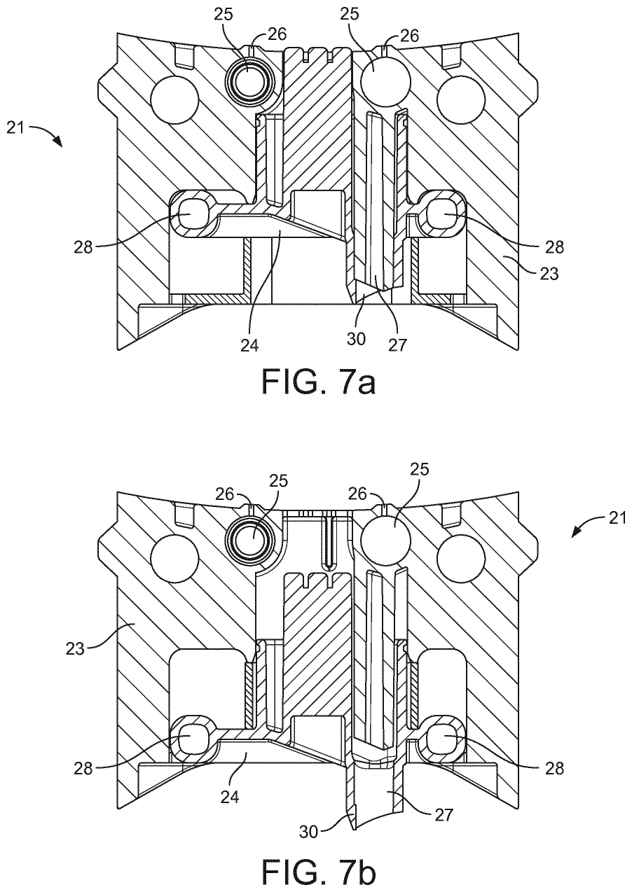

A possible configuration of the insert 21 is represented in FIG. 6a: FIG. 6b shows a cut according to A-A. Another embodiment of the insert 21 is represented in FIGS. 7a and 7b.

Looking at the configuration of the insert 21 shown in FIGS. 6a and 6b, it comprises two parts, relatively moveable with respect to each other, typically in a linear way. The insert 21 comprises a fixed part 23 and a moveable part 24, the moveable part 24 displacing substantially vertically with respect to the fixed part 23. Piercing and injecting means from the device 10 (not shown), typically configured as a needle, pierce the film covering the frontal part of an inlet 25 and inject a fluid, typically water, at high pressure. These piercing and injecting means are typically configured as a fluid needle, comprising an inner duct or pipe through which high pressure fluid is injected in the inlet 25.

Preferably, fluid is injected at a pressure higher than 2 bars, more preferably higher than 3 bars, preferably comprised between 2 and 10 bars, more preferably of around 7 bars. The inlet 25 is configured in such a way that the high pressure fluid injected through it by the injecting and piercing means is converted into a high velocity jet, which is driven into the container. Typically, the diameter of the inlet is comprised between 1 mm and 4 mm, more preferably between 1.5 mm and 3 mm and comprises a yieldably cover over that can be pierced by the injecting and piercing means. The injecting and piercing means will also typically comprise a toroidal ring, preferably made of rubber, ensuring that there is no leakage of fluid outside the inlet while the injecting and piercing means are injecting fluid into the fluid inlet. The inlet 25 is communicated with the inside volume of the container through at least one injection hole 26, having a diameter of at most 1 mm, preferably of at least 0.24 mm, preferably comprised between 0.3 mm and 1 mm, preferably between 0.3 and 0.5 mm, more preferably of about 0.4 mm. With such a configuration, when high pressure fluid is injected by the injecting and piercing means through the inlet 25, it is conveyed internally towards the injection hole 26, from which it is converted into a high velocity jet of fluid injected inside the container 20 when passing through the small section injection hole. Typically, this jet of fluid provided in the container has a velocity of at least 20 m/s.

According to the invention, the inlet can also be configured for providing an orientable high velocity jet into the container, preferably at about 90° with respect to the fluid supply provided into the inlet by the injecting and piercing means, though any other angle would be possible and comprised within the scope of the present application.

As described, the inlet 25 together with the injection hole 26 in the insert 21 are configured for introducing the fluid under the form of a jet in the inner volume of the container 20. By jet it is understood a stream of liquid or fluid that comes out of the inlet and into the inner volume of the food or beverage container quickly and with force. The inlet 25 is configured for introducing fluid in the inner volume of the container with a high velocity, this fluid jet preferably presenting a velocity of at least about 20 m/s, preferably at least 30 m/s. As previously described, such a configuration is preferably obtained in the present invention by placing a constriction (that of the injection hole 26) in the fluid path in the inlet to reduce the size of the section of the inlet. Due to the small surface of the injection hole 26 through which the fluid goes into the inner volume of the container 20, the pressurized fluid creates a jet in the inner volume of the container.

For the same fluid to be provided through the inlet 25, the surface of the injection hole 26 can vary according to the nature of the food and beverage ingredient inside the container which is to be mixed with the fluid. In particular when the ingredient is difficult to dissolve a smaller injection hole creates a jet with a higher velocity which improves agitation and dissolution of this ingredient in the container.

Once the beverage or food inside the container 20 has been prepared, corresponding means from the device 10 (not shown) engage the positioning holes 28 in the moveable part 24, displacing substantially linearly downwards the moveable part 24 with respect to the fixed part 23, which remains fixed to the device 10. The moveable part 24 comprises sharpened elements 30 (see FIG. 6b) that tear open the film overwrapping the lower part of the insert 21, so communication to the outside of the container 20 is open. By displacing the moveable part 24 with respect to the fixed part 23, the communication of the inner volume 22 of the container 20 is open through the elements 29 towards the outlet 27 and into the exterior of the insert 21, so the beverage or food can be dispensed into the receptacle 70.

Another embodiment of the insert 21 is shown in FIGS. 7a and 7b. The working principle of the insert 21 is similar as the one represented in FIGS. 6a and b. The insert 21 comprises two inlets 25, through which a fluid is injected into the inner volume 22 of the container 20 by means of two inlet holes 26. There is also a fixed part 23 to the device 10 with respect to which a moveable part 24 displaces, tearing open the film overwrapping the lower side of the insert 21 by the sharpened part 30 and opening the communication from the inner volume 22 of the container into the outlet 27 to the outside for delivering the food or beverage. Contrary to the embodiment of FIGS. 6a-b, where there is an inlet 25 in the middle part of the insert 21, the insert 21 of FIGS. 7a-b comprises two inlets 25 with two injection holes 26 delivering two jets inside the container for dissolution of the food or beverage ingredient, typically as powder, inside.

As represented in FIGS. 6a-b and 7a-b, the insert 25 can be accessed frontally or on the rear side, therefore allowing the container 20 be placed in the holding means 30 on any positioning as it is configured being reversible. This represents a very important advantage for the consumer's convenience, as a user of the device 10 does not have to place in a specific position the containers in the holding means, as either frontally or reversely, they will be able to be correctly processed by the device 10.

The outlet 27 in the insert 21 through which the food product or beverage is dispensed is configured so that it delivers the product as a free flow, meaning that the product can flow by simple gravity fall. The outlet 27 is typically configured as a straight tube oriented essentially vertically in the insert 21. The length of the tube is preferably of at least 5 mm: such a length generally enables a finalisation of the froth of the product, typically a beverage, before it is delivered in a receptacle 70.

The insert 21 is preferably rigid and is made of a rigid plastic material, preferably by injection moulding. Typically, this plastic material can be selected from the following: polypropylene, polyethylene, polyethylene terephthalate and polylactic acid. Also according to a less preferred embodiment the fitment assembly 10 can be made of a metal like aluminium or tin-plate.

In the embodiments described for the insert 21, once the delivery of the beverage ends, the moveable part 24 can go back to its first positioning, thus closing again the communication with the inner volume 22 of the container by closing the elements 29 allowing that, when the pack is removed from the device, no dripping occurs.

The device of the invention is configured to be of the direct flow type, and there is no beverage or food touching parts of the device, so having very high hygiene functioning and needed almost no cleaning. The main part interacting with the beverage is the insert 21 of each container 20, which represents the interface with the device. Such unique interface represents also an important advantage for the configuration of the system 100 of the invention, as the containers can be differently configured (different sizes or even external shapes, for example) and will still maintain the common interface in the insert with respect to the device.

According to the invention, the device 10 is provided with a data reader to retrieve information from identification means arranged on the container 20. These identification means will comprise information on the processing of the ingredients in the inner volume 22: the reader will provide the information to an appropriate control unit in the device. This information can comprise for example the parameters for the preparation process, such as: temperature of the fluid introduced, flow and total volume of the fluid, preparation time, sequences of relative movement of primary and secondary parts in the fitment assembly, etc.

Also, when two container 20 and 20′ are placed in the holding means 30 and are processed by the device 10, they can either be processed simultaneously and/or sequentially, thus providing a very wide variety of recipes that can be obtained. Moreover, the user can act on the interface 80 and can modify certain parameters of the preparation, so as to obtain a personalized food or beverage.

The operation of the insert 21 as to opening, partial opening and closing, managed by the displacement of the moveable part 24 with respect to the fixed part 23, allows processing the content and delivery of the food or beverage in each container as desired, and also simultaneously and/or sequentially. Therefore, a wide possibility of preparation of beverages from the containers is offered. A preferred operation will be provided for each container, though this operation can be modified by a user through the interface 80.

These identification means can comprise any kind of recognition means such as, for example, mechanical codes, optical codes, RFID tags, bar codes, magnetic codes, or the like. These identification means can also be made as detection holes arranged for example on one lateral edge of the food or beverage container, configured by the two flexible sheets brought together to conform the pouch or container, preferably on the sealing area of the container, where there is no product or ingredient. When the two sheets are brought together and are welded on the edges to configure a container, on one of these lateral edges, additional welding with circumferential shape will be provided, thus configuring the holes as punching holes. A plurality of holes will typically be provided vertically on one of the edges of the container brought together: these holes will allow light to pass through and, depending on the configuration of the holes, the machine will be provided with the information for the processing of the container that has to be followed. Because the packs 20 according to the present invention are made reversible, in order to allow the machine read the identification means independently on the sense in which the pack 20 has been introduced, these identification means, typically these detection holes or punched holes, will be provided on two lateral edges of the container. The identification means can also provide the machine with the information regarding the sense of introduction of the pack.

The device 10 can also be provided with heating means that will heat the fluid (typically water) to a certain temperature before introducing it into the container 20. According to the present invention, the fluid can be supplied to the container 20 at any temperature, cold, ambient or hot, depending on the type of food or beverage product targeted.

According to a second aspect, the invention relates to a method for preparing a food or beverage using a device 10 as the one described earlier. The method prepares a food or a beverage from one, most preferably from two containers 20 and 20′ positioned in holding means 30. The content of the containers is either prepared sequentially and/or simultaneously and is dispensed, sequentially and/or simultaneously, in a receptacle 70, depending on the desired recipe (the recipe can be given directly by identification means or it can be given directly by the user's interface 80, or can be modified and personalized by this interface 80). The preparation of the content in each container in the holding means 30 is done in the same way, by injecting a fluid (water) that will dissolve the content; the content will be then dispensed by moving the moveable part of the insert with respect to the fixed part, to free the communication from the inner volume 22 of the container towards the receptacle 70. Then, once the beverage or food product has been prepared, the holding means 30 can be removed from the device 10 typically by pulling them out and sliding them through the guiding means 61. Then, the container or containers in the holding means 30 can be removed from the holding means 30 and can be pulled out without any dripping of the product inside, as the insert 21 will be closed (i.e. the communication of the outlet 27 with the inner volume 22 of the container will be closed).

Although the present invention has been described with reference to preferred embodiments thereof, many modifications and alternations may be made by a person having ordinary skill in the art without departing from the scope of this invention which is defined by the appended claims.

1. Food or beverage dispensing device comprising a holding member accepting at least two containers of similar configuration;
the holding member being configured to cooperate with a receiving member in the device to insert and position the at least two containers in the device for preparing a food or beverage, each container comprising at least an ingredient for the preparation of a food or beverage;
the holding member comprising a positioning member to position in a certain manner the containers in the holding member and also comprising an interface area for each of the containers placed, such that free access is left to operate the containers injecting a fluid for the preparation of the food or beverage and to open and/or close the dispensing outlet of the food or beverage prepared.

2. Food or beverage dispensing device according to claim 1 wherein the at least two containers are configured as flexible pouches or sachets.

3. Food or beverage dispensing device according to claim 2 wherein the containers are configured with at least a flexible sheet configuring an inner volume where at least a food or beverage ingredient is arranged, the containers being also provided with an insert used as interface with the device.

4. Food or beverage dispensing device according to claim 3 wherein the at least one flexible sheet is arranged overwrapping the insert in its entirety, except for the part of it communicating with the inner volume of the container.

5. Food or beverage dispensing device according to claim 1 wherein the at least two containers can differ in height and/or internal volume.

6. Food or beverage dispensing device according to claim 1 comprising a unique fluidic system configured for the delivery of fluid to the at least two containers.

7. Food or beverage dispensing device according to claim 1 wherein the holding member is configured to be completely and/or partially removable from the device.

8. Food or beverage dispensing device according to claim 1 wherein the containers present a plane shape oriented along a plane substantially vertically oriented during food or beverage preparation.

9. Food or beverage dispensing device according to claim 1 comprising an interface member engaging with each one of the containers in the holding member, once introduced in the device.

10. Food or beverage dispensing device according to claim 9 wherein the interface member is arranged opposed to engage with opposed containers in the holding member.

11. Food or beverage dispensing device according to claim 1 wherein the at least two containers comprise an identification member to engage with a reader in the device and provide information on the processing and dispensing parameters of the food or beverage product.

12. Food or beverage dispensing device according to claim 11 wherein the identification member is configured as mechanical codes, optical codes, RFID tags, bar codes, magnetic codes or the like.

13. Food or beverage dispensing device according to claim 1 further comprising a user interface to retrieve information from a user with respect to the processing parameters of the containers in the holding member.

14. Food or beverage dispensing device according to claim 1 wherein one of the containers comprises a base product for the food or beverage to prepare, a second container comprising a complementary ingredient for the food or beverage.

15. Food or beverage dispensing system comprising a food or beverage dispensing device comprising a holding member accepting at least two containers of similar configuration, the holding member being configured to cooperate with a receiving member in the device to insert and position the at least two containers in the device for preparing a food or beverage, each container comprising at least an ingredient for the preparation of a food or beverage, the holding member comprising a positioning member to position in a certain manner the containers in the holding member and also comprising an interface area for each of the containers placed, such that free access is left to operate the containers injecting a fluid for the preparation of the food or beverage and to open and/or close the dispensing outlet of the food or beverage prepared and at least two containers provided on holding member.

16. Method for preparing a food or beverage using a food or beverage dispensing system comprising a holding member accepting at least two containers of similar configuration, the holding member being configured to cooperate with a receiving member in the device to insert and position the at least two containers in the device for preparing a food or beverage, each container comprising at least an ingredient for the preparation of a food or beverage, the holding member comprising a positioning member to position in a certain manner the containers in the holding member and also comprising an interface area for each of the containers placed, such that free access is left to operate the containers injecting a fluid for the preparation of the food or beverage and to open and/or close the dispensing outlet of the food or beverage prepared comprising:
providing at least two containers in the holding member and positioning them inside the device; and
engaging each of the containers with the interface member of the device, injecting a fluid inside the containers to prepare a food or beverage, the interface member also operating the opening and/or closing of the dispensing of the food or beverage product prepared.

17. Method for preparing a food or beverage according to claim 16 wherein the preparation and/or the dispensing of the food or beverage is done simultaneously or sequentially.
